(19) United States
(12) Patent Application Publication
(10) Pub. No.: US 2024/0192360 A1
(43) Pub. Date: Jun. 13, 2024

(54) DRIVING ASSISTANCE SYSTEM AND DRIVING ASSISTANCE METHOD

(71) Applicant: HL KLEMOVE CORP., Incheon (KR)

(72) Inventor: Yongbin KWAK, Incheon (KR)

(21) Appl. No.: 18/234,448

(22) Filed: Aug. 16, 2023

(30) Foreign Application Priority Data
Dec. 9, 2022 (KR) 10-2022-0171522

(51) Int. Cl. G01S 13/931; G01S 7/02; G01W 1/14

(52) U.S. Cl. CPC G01S 13/931; G01S 7/02; G01W 1/14

(57) ABSTRACT

A driving assistance system according to one embodiment includes: a radar configured to emit a transmission signal around a vehicle, and receive reflected signals reflected from an object around the vehicle; and a processor configured to filter a noise signal included in the reflected signals received by the radar in a rainy environment or snowy environment, wherein the processor sets a filtering condition of the noise signal based on the precipitation amount, determines a reflected signal corresponding to the set filtering condition among the reflected signals received by the radar as the noise signal, and filters the determined noise signal.

### CROSS-REFERENCE TO RELATED APPLICATION

This application claims the benefit of Korean Patent Application No. 10-2022-0171522, filed on Dec. 9, 2022 in the Korean Intellectual Property Office, the disclosure of which is incorporated herein by reference.

### BACKGROUND

### 1. Field

Embodiments of the present disclosure relate to a driving assistance apparatus and a driving assistance method, and more specifically, a driving assistance apparatus and a driving assistance method capable of removing noise signals of a radar in rainy weather.

### 2. Description of the Related Art

Vehicles are the most common transportation means in modern society, and the number of people using vehicles is increasing. Although there are advantages in that long-distance travel is easy, living becomes comfortable, and the like due to the development of vehicle technology, a problem of road traffic conditions deteriorating and thus traffic congestion becoming severe often occurs in densely populated places such as Korea.

Recently, in order to reduce a driver's burden and improve convenience, research on vehicles equipped with an advanced driver assistance system (ADAS) which actively provides information on a vehicle condition, a driver's condition, or the surrounding environment is actively proceeding.

For example, advanced driver assistance systems equipped in vehicles can perform a function such as lane departure warning (LDW), lane keeping assist (LKA), high beam assist (HBA), and autonomous emergency braking (AEB), traffic sign recognition (TSR), adaptive cruise control (ACC), blind spot detection (BSD), or the like.

Meanwhile, these driver assistance systems can perform the above-described functions based on data acquired by at least one detecting device of a radar, a light detection and ranging system (lidar), or a camera.

### SUMMARY

Therefore, it is an aspect of the present disclosure to provide a driving assistance apparatus and a driving assistance method capable of preventing the deterioration of performance of a radar due to rain or snow in an environment by reflecting environmental influences to remove noise signals of the radar.

Additional aspects of the disclosure will be set forth in part in the description which follows and, in part, will be obvious from the description, or may be learned by practice of the disclosure.

In accordance with one aspect of the present disclosure, a driving assistance apparatus includes: a radar configured to emit a transmission signal around a vehicle, and receive reflected signals reflected from an object around the vehicle; and a processor configured to filter a noise signal included in the reflected signals received by the radar in a rainy environment or snowy environment, wherein the processor sets a filtering condition of the noise signal based on a precipitation amount, determines a reflected signal corresponding to the set filtering condition among the reflected signals received by the radar as the noise signal, and filters the determined noise signal.

The filtering condition may include at least one of an angle corresponding to the reflected signal, a speed corresponding to the reflected signal, a distance corresponding to the reflected signal, or an intensity corresponding to the reflected signal.

The processor may determine the precipitation amount based on an output of a rain sensor provided in the vehicle and a cumulative detection amount of a noise estimation signal included in the reflected signals.

The processor may determine the precipitation amount based on at least one of an output of a rain sensor provided in the vehicle, an output of a camera provided in the vehicle, or an output of a light detection and ranging system (lidar) provided in the vehicle and the cumulative detection amount of the noise estimation signal included in the reflected signals.

The processor may determine a reflected signal having a detected intensity smaller than or equal to a threshold value, and a corresponding speed smaller than a speed of the vehicle among the reflected signals as the noise estimation signal.

The processor may determine a reflected signal having a detected intensity smaller than or equal to a threshold value, and a corresponding speed smaller than a speed of the vehicle among the reflected signals as the noise estimation signal.

The processor may adjust the filtering condition according to at least one of a mounting position or a function of the radar.

The processor may set an angle and a distance included in the filtering condition to be large for a radar mounted on the rear of the vehicle, and may set an angle and a distance included in the filtering condition to be small for a radar mounted on the front of the vehicle.

In accordance with another aspect of the present disclosure, a driving assistance system includes: a radar configured to transmit a transmission signal around a vehicle, and receive reflected signals reflected from an object around the vehicle; and a processor configured to cluster the reflected signals to generate a track corresponding to the object, wherein the processor increases a minimum detection amount of the reflected signal for generating the track when the precipitation amount included in a first range, and adjusts an antenna beam pattern of the radar to avoid a water spray section when the precipitation amount is included in a second range.

The processor may adjust at least one of a beam width or a beam angle of the radar when the precipitation amount is included in the second range.

The radar may include a first transmission antenna used in a normal environment and a second transmission antenna used in a rainy environment, and the processor may turn on and off the first transmission antenna and the second transmission antenna based on the precipitation amount.

The processor may turn on the first transmission antenna and turn off the second transmission antenna when the precipitation amount is included in the first range, and may turn on the second transmission antenna and turn off the first transmission antenna when the precipitation amount is included in the second range.

In accordance with still another aspect of the present disclosure, a driving assistance method includes: emitting, by a radar, a transmission signal around a vehicle; receiving reflected signals reflected from an object around the vehicle; and filtering a noise signal included in the reflected signals received by the radar in a rainy environment or snowy environment, wherein the filtering includes setting a filtering condition of the noise signal based on a precipitation amount, determining a reflected signal corresponding to the set filtering condition among the reflected signals received by the radar as the noise signal, and filtering the determined noise signal.

The filtering condition may include at least one of an angle corresponding to the reflected signal, a speed corresponding to the reflected signal, a distance corresponding to the reflected signal, or an intensity corresponding to the reflected signal.

The filtering may include determining the precipitation amount based on an output of a rain sensor provided in the vehicle and a cumulative detection amount of a noise estimation signal included in the reflected signals.

The filtering may include determining the precipitation amount based on at least one of an output of a rain sensor provided in the vehicle, an output of a camera provided in the vehicle, or an output of the lidar provided in the vehicle and the cumulative detection amount of the noise estimation signal included in the reflected signals.

The filtering may include determining a reflected signal having a detected intensity smaller than or equal to a threshold value, and the corresponding speed smaller than a speed of the vehicle among the reflected signals as the noise estimation signal.

The filtering may include determining a reflected signal having a detected intensity smaller than or equal to a threshold value, and the corresponding speed smaller than a speed of the vehicle among the reflected signals as the noise estimation signal.

The filtering may include determining a reflected signal having the detected intensity smaller than or equal to the threshold value, and the corresponding speed smaller than the speed of the vehicle among the reflected signals as the noise estimation signal.

The filtering may include adjusting the filtering condition according to at least one of a mounting position or a function of the radar.

The filtering may include setting an angle and a distance included in the filtering condition to be large for a radar mounted on the rear of the vehicle, and setting an angle and a distance included in the filtering condition to be small for a radar mounted on the front of the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating operations of a vehicle and a driving assistance system included in the vehicle according to one embodiment;

FIG. 2 illustrates a field of view of a camera, a radar, and a light detection and ranging system (lidar) included in the vehicle according to one embodiment;

FIG. 3 is a flow chart illustrating a general process in which a radar track is generated;

FIG. 4 is a flow chart related to a driving assistance method according to one embodiment;

FIG. 5 is a flow chart which shows an operation of filtering the reflected signals in the driving assistance method according to one embodiment in detail;

FIGS. 6 and 7 are views illustrating examples of a region of interest (ROI) of the radar included in the driving assistance system according to one embodiment;

FIGS. 8 to 10 are views illustrating examples of the filtering condition applied to the driving assistance system and the driving assistance method according to one embodiment;

FIG. 11 is a flow chart of a driver's control method according to another example; and

FIG. 12 is a view illustrating a control operation according to a driver's control method according to another embodiment.

### DETAILED DESCRIPTION

Embodiments disclosed in the present specification and components shown in the drawings are preferable examples of the present disclosure, and there may be various modifications capable of the embodiments and drawings of the present specification at the time of filing the present application.

Further, the same reference numerals or numerals presented in each drawing in the present specification indicate parts or components which perform substantially the same function.

In addition, terms used in the present specification are used to describe the embodiments, and are not intended to limit and/or restrict the present disclosure.

A singular form also includes a plural form unless otherwise defined.

In the present specification, terms such as “include,” “including,” “provide,” “providing,” “have,” and/or “having” are intended to indicate the presence of a feature, number, step, operation, component, part, or a combination thereof described in the specification, and do not exclude the possibility of the presence or addition of one or more other features or numbers, steps, operations, components, parts or combinations thereof in advance.

Further, terms including ordinal numbers such as “first,” “second,” and the like used in the present specification may be used to describe various components, but the components are not restricted by the terms, and the terms are used only for a purpose of distinguishing one component from another component. For example, a first component may be called a second component, and similarly, the second component may be called the first component without departing from the scope of the present disclosure.

The term “and/or” includes a combination of a plurality of related listed items or any one item of the plurality of related listed items.

Further, terms such as “˜ unit,” “˜ group,” “˜ block,” “˜ member,” “˜ module,” and the like may refer to units which process at least one function or operation. For example, the terms may refer to at least one piece of hardware such as a field-programmable gate array (FPGA), an application specific integrated circuit (ASIC), or the like, at least one piece of software stored in a memory, or at least one process processed by a processor.

Numerals respectively attached to operations are used to respectively identify the operations, and these numerals do not indicate the order of the operations, and the operations may be performed in a different order from a specified order unless a specific order is clearly stated in the context.

The expression “at least one” used when a list of elements in the specification is mentioned may change a combination of the elements. For example, it may be understood that the expression “at least one of a, b, or c” indicates only a, only b, only c, both a and b, both a and c, both b and c, and a combination of all of a, b, and c.

Hereinafter, the embodiments of the present disclosure will be described with reference to the accompanying drawings.

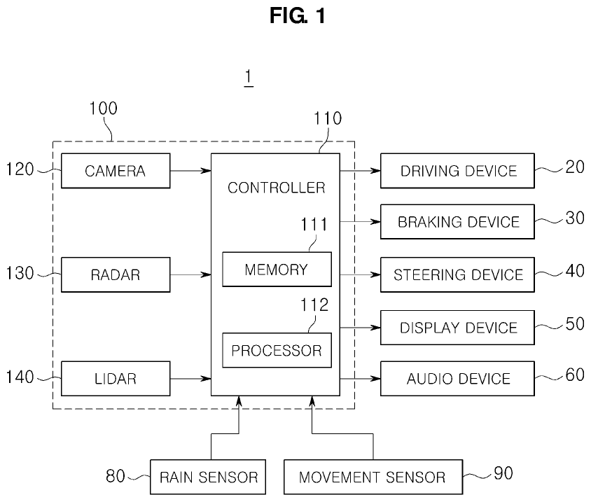

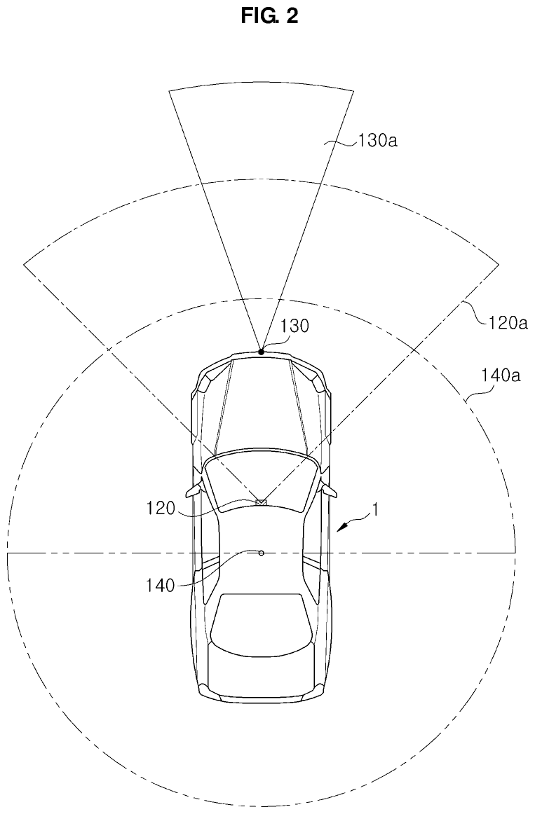

FIG. 1 is a block diagram illustrating operations of a vehicle and a driving assistance system included in the vehicle according to one embodiment, and FIG. 2 illustrates a field of view of a camera, a radar, and a light detection and ranging system (lidar) included in the vehicle according to one embodiment.

As shown in FIG. 1, a vehicle 1 includes a navigation device 10, a driving device 20, a braking device 30, a steering device 40, a display device 50, an audio device 60, and a driving assistance system 100.

Further, the vehicle 1 may further include a rain sensor 80 capable of detecting the precipitation amount. For example, the rain sensor 80 may include a light-emitting diode which emits light and a photodiode which receives light, and may be provided on a windshield of the vehicle 1.

When infrared rays are emitted from the light-emitting diode of the rain sensor 80, the emitted infrared rays may be reflected by an object around the rain sensor 80 and may be incident on the photodiode. The amount of reflected light incident on the photodiode decreases as the precipitation amount is large. Accordingly, the precipitation amount may be determined based on the amount of infrared rays received by the photodiode.

Further, the vehicle 1 may further include a movement sensor 90 which detects movement of the vehicle 1. For example, the movement sensor 90 may include at least one of a vehicle speed sensor which detects the longitudinal speed of the vehicle 1, an acceleration sensor which detects the longitudinal acceleration and lateral acceleration of the vehicle 1, or a gyro sensor which detects the yaw rate, roll rate, and pitch rate of the vehicle 1.

The above-described components may exchange data with each other through a vehicle communication network. For example, the above-described components included in the vehicle 1 may exchange data with each other through a vehicle communication network such as an Ethernet, media oriented systems transport (MOST), FlexRay, a controller area network (CAN), a local interconnect network (LIN), or the like.

The navigation device 10 may generate a route to a destination input by a driver, and provide the generated route to the driver. The navigation device 10 may receive a global navigation satellite system (GNSS) signal from a GNSS, and identify an absolute position (coordinates) of the vehicle 1 based on the GNSS signal. The navigation device 10 may generate a route to the destination based on the position (coordinates) of the destination input by the driver and a current position (coordinates) of the vehicle 1.

For example, the navigation device 10 may provide map data and position information of the vehicle 1 to the driving assistance system 100. Further, the navigation device 10 may provide information on the route to the destination to the driving assistance system 100. Specifically, the navigation device 10 may provide information, such as a distance to an access road for the vehicle 1 to enter a new road, a distance to an exit road for the vehicle 1 to exit from the road it currently travels on, or the like to the driving assistance system 100.

The driving device 20 generates power required to move the vehicle 1. For example, the driving device 20 may include an engine, an engine management system (EMS), a transmission, and a transmission control unit (TCU).

The engine generates power for driving the vehicle 1, and the engine management system may control the engine in response to the driver's intent to accelerate through an accelerator pedal or a request of the driving assistance system 100. The transmission transmits the power generated by the engine to wheels for deceleration, and the transmission control unit may control the transmission in response to a driver's shift command through a shift lever and/or a request of the driving assistance system 100.

Alternatively, the driving device 20 may also include a driving motor, a decelerator, a battery, a power control device, and the like. In this case, the vehicle 1 may be implemented as an electric vehicle.

Alternatively, the driving device 20 may include both devices related to the engine and devices related to the driving motor. In this case, the vehicle 1 may be implemented as a hybrid vehicle.

The braking device 30 stops the vehicle 1 and may include, for example, a brake caliper and a brake control module (EBCM). The brake caliper may decelerate the vehicle 1 or stop the vehicle 1 using friction with a brake disc.

An electronic brake control module may control the brake caliper in response to the driver's intent to brake through a brake pedal or a request of the driving assistance system 100. For example, the electronic brake control module may receive a deceleration request including a deceleration rate from the driving assistance system 100, and control the brake caliper electrically or hydraulically so that the vehicle 1 may decelerate based on the requested deceleration rate.

The steering device 40 may include an electronic power steering control module (EPS). The steering device 40 may change a driving direction of the vehicle 1, and the electronic power steering control module may assist operation of the steering device 40 in response to the driver's intent to steer through a steering wheel so that the driver may easily operate the steering wheel.

Further, the electronic power steering control module may control the steering device 40 in response to a request of the driving assistance system 100. For example, the electronic power steering control module may receive a steering request including steering torque from the driving assistance system 100, and control the steering device 40 based on the requested steering torque so that the vehicle 1 may be steered.

The display device 50 may include a cluster, a head-up display, a center fascia monitor, and the like, and may provide various types of information and entertainment to the driver through images and sounds. For example, the display device 50 may provide driving information of the vehicle 1, a warning message, and the like to the driver.

The audio device 60 may include a plurality of speakers, and provide various types of information and entertainment to the driver through sounds. For example, the audio device 60 may provide the driving information of the vehicle 1, the warning message, and the like to the driver.

The driving assistance system 100 according to one embodiment may communicate with the navigation device 10, the movement sensor 90, the driving device 20, the braking device 30, the steering device 40, the display device 50, and the audio device 60 through a vehicle communication network.

The driving assistance system 100 may receive information on the route to the destination and the position information of the vehicle 1 from the navigation device 10, and may receive the information on the vehicle speed, acceleration, or the angular velocity of the vehicle 1 from the vehicle movement sensor 90.

The driving assistance system 100 may provide various functions for safety to the driver, and furthermore, may be used in autonomous driving of the vehicle 1. For example, the driving assistance system may provide functions such as lane departure warning (LDW), lane keeping assist (LKA), high beam assist (HBA), and autonomous emergency braking (AEB), traffic sign recognition (TSR), adaptive cruise control (ACC), blind spot detection (BSD), and the like.

The driving assistance system 100 may include a controller 110, a camera 120, a radar 130, and a lidar 140.

The controller 110, the camera 120, the radar 130, and the lidar 140 may be provided to be physically separated from each other. For example, the controller 110 may be installed in a housing separated from a housing of the camera 120, a housing of the radar 130, and a housing of the lidar 140. The controller 110 may exchange data with the camera 120, the radar 130, or the lidar 140 through a broad bandwidth network.

Alternatively, at least some of the camera 120, the radar 130, the lidar 140, and the controller 110 may be provided to be integrated. For example, the camera 120 and the controller 110 may be provided in the same housing, the radar 130 and the controller 110 may be provided in the same housing, or the lidar 140 and the controller 110 may be provided in the same housing.

The camera 120 may capture the surroundings of the vehicle 1 and acquire image data on the surroundings of the vehicle 1. For example, as shown in FIG. 2, the camera 120 may be installed on a front windshield of the vehicle 1, and have a field of view 120a facing the forward direction of the vehicle 1.

The camera 120 may include a plurality of lenses and an image sensor. The image sensor may include a plurality of photodiodes which convert light to electrical signals, and the plurality of photodiodes may be mounted in a two-dimensional matrix form.

The image data may include information on other vehicles located around the vehicle 1, pedestrians, cyclists, or lanes (markers which distinguish roads).

The driving assistance system 100 may include a processor which processes image data of the camera 120, and for example, the processor may be a component included in the camera 120, and may also be a component included in the controller 110.

The processor may acquire the image data from the image sensor of the camera 120, and detect and identify and objects around the vehicle 1 based on processing of the image data. For example, the processor may perform image processing to generate tracks corresponding to the objects around the vehicle 1, and classify the generated tracks. The processor may identify whether the track is another vehicle, a pedestrian, a cyclist, or the like, and assign an identification code to the track.

The processor may transmit data (or positions and classification of the tracks) on the tracks around the vehicle 1 (hereinafter, referred to as ‘camera tracks’) to the controller 110. The controller 110 may perform a function of assisting the driver based on the camera tracks.

The radar 130 may transmit radio waves around the vehicle 1 and detect the objects around the vehicle 1 based on reflected radio waves reflected from the surrounding objects. For example, as shown in FIG. 2, the radar 130 may be installed on a grill or bumper of the vehicle 1, and have a field of view of detection (field of sensing) 120a facing the forward direction of the vehicle 1.

The radar 130 includes a transmission antenna (or a transmission antenna array) which emits transmission signals, that is, transmission radio waves, around the vehicle 1, and a reception antenna (or a reception antenna array) which receives reflected signals, which are reflected from the objects and then return, that is, the reflected radio waves.

The radar 130 may acquire radar data from the transmission waves emitted by the transmission antenna and the reflected waves received by the reception antenna. The radar data may include position information (for example, distance information) or information on a speed of an object located in front of the vehicle 1.

The driving assistance system 100 may include a processor which processes the radar data, and for example, the processor may be a component included in the radar 130, and may also be a component included in the controller 110.

The processor may acquire the radar data from the reception antenna of the radar 130 and generate the tracks corresponding to the objects by clustering reflection points of the reflected signals. For example, the processor may acquire a distance of the track based on a time difference between the transmission time of the transmitted radio waves and the reception time of the reflected radio waves, and may acquire a relative speed of the track based on a difference between the frequency of the transmitted radio waves and the frequency of the reflected radio waves.

The processor may transmit data on the tracks around the vehicle 1 (hereinafter, referred to as ‘radar tracks’) (or the distance and the relative speed of the track) acquired from radar data to the controller 110. The controller 110 may perform a function of assisting the driver based on the radar tracks.

The lidar 140 may emit light (for example, an infrared ray) around the vehicle 1 and detect the objects around the vehicle 1 based on reflected light reflected from the surrounding objects. For example, as shown in FIG. 2, the lidar 140 may be installed on a roof of the vehicle 1, and have a field of view 140a facing all directions around the vehicle 1.

The lidar 140 may include a light source (for example, a light-emitting diode, a light-emitting diode array, a laser diode, or a laser diode array) which emits the light (for example, infrared rays or the like), and an optical sensor (for example, a photodiode or a photodiode array) which receives the light (for example, infrared rays or the like). Further, as necessary, the lidar 140 may further include a driving device which rotates the light source or the optical sensor.

The lidar 140 may emit the light through the light source and receive the light reflected from the object through the light sensor while the light source or the light sensor rotates, and accordingly, may acquire lidar data.

The lidar data may include relative positions (the distances or directions of the surrounding objects) or relative speeds of the objects around the vehicle 1.

The driving assistance system 100 may include a processor capable of processing the lidar data, and for example, the processor may be a component included in the lidar 140 and may also be a component included in the controller 110.

The processor may generate the tracks corresponding to the objects by clustering the reflection points by the reflected light. For example, the processor may acquire a distance to the object based on a time difference between a light transmission time and a light reception time. Further, the processor may acquire the direction (or an angle) of the object with respect to the driving direction of the vehicle 1 based on a direction in which the light source emits the light when the optical sensor receives the reflected light.

The processor may transfer the data on the tracks around the vehicle 1 (hereinafter, referred to as ‘lidar tracks’) (or the distances and the relative speeds of the tracks) acquired from the lidar data to the controller 110.

The controller 110 may be implemented as at least one electronic control unit (ECU) or domain control unit (DCU) electrically connected to the camera 120, the radar 130, or the lidar 140.

Further, as described above, the controller 110 may include at least one processor which generates a camera track, a radar track, or a lidar track.

In addition, the controller 110 may be connected to other components of the vehicle 1 such as the navigation device 10, the driving device 20, the braking device 30, the steering device 40, the display device 50, the audio device 60, and the vehicle movement sensor 90.

The controller 110 may process the camera track (or the image data) of the camera 120, the radar track (or the radar data) of the radar 130, or the lidar track (or the lidar data) of the lidar 140, and provide a control signal to the driving device 20, the braking device 30, or the steering device 40.

The controller 110 may include at least one memory 111 in which a program for performing the following operation is stored and at least one processor 112 which executes the stored program.

The controller 110 may be provided as a separate component from the radar 130, and may also be integrally provided. In the latter case, the processor 112 of the controller 110 may include the processor of the above-described radar 130.

Further, the memory 111 may store a program or data for processing the image data, the radar data, or the lidar data. In addition, the memory 111 may store a program or data for generating driving/braking/steering signals.

The memory 111 may temporarily store the image data received from the camera 120, the radar data received from the radar 130, or the lidar data received from the lidar 140, and temporarily store a processing result of the image data, the radar data, or the lidar data of the processor 141.

Also, the memory 111 may include a high definition map (HD Map). Unlike general maps, the high definition map may include detailed information on a surface of road or an intersection, such as a lane, a traffic light, an intersection or a road sign, or the like. Specifically, in the high definition map, a landmark (for example, a lane, a traffic light, an intersection, a road sign, or the like) that a vehicle encounters while the vehicle is driven is three-dimensionally implemented.

The memory 111 may include not only volatile memories such as a static random access memory (S-RAM), a dynamic random access memory (D-RAM), and the like but also non-volatile memories such as a flash memory, a read only memory (ROM), an erasable programmable read only memory (EPROM), and the like.

The processor 112 may process a camera track of the camera 120, a radar track of the radar 130, or a lidar track of the lidar 140. For example, the processor 112 may fuse the camera track, the radar track, and the lidar track, and output a fusion track.

The processor 112 may generate a driving signal, a braking signal, and a steering signal for respectively controlling the driving device 20, the braking device 30, and the steering device 40 based on processing the fusion track. For example, the processor 112 may evaluate the risk of collision between the fusion tracks and the vehicle 1. The processor 112 may the control the driving device 20, the braking device 30, or the steering device 40 to steer or brake the vehicle 1 based on the risk of collision between the fusion tracks and the vehicle 1.

The processor 112 may include an image processor which processes the image data of the camera 120, a signal processor which processes the radar data of the radar 130 or the lidar data of the lidar 140, or a micro control unit (MCU) which generates the driving/braking/steering signals.

As described above, the controller 110 may provide the driving signal, the braking signal, or the steering signal based on the image data of the camera 120, the radar data of the radar 130, or the lidar data of the lidar 140.

A specific operation of the driving assistance system 100 will be described below in more detail.

Further, although not shown in the drawing, the vehicle according to one embodiment may further include a communication module capable of communicating with other external devices. The communication module may wirelessly communicate with a base station or an access point (AP), and exchange data with the external devices through the base station or the access point.

For example, the communication module may wirelessly communicate with the access point (AP) using WiFi (WiFi™, technical standard of the IEEE 802.11) or communicate with the base station using code division multiple access (CDMA), wideband code division multiple access (WCDMA), global system for mobile communications (GSM), long term evolution (LTE), fifth-generation (5G), wireless broadband (WiBro), or the like.

In addition, the communication module may also directly communicate with the external devices. For example, the communication module may exchange data with the external devices in a short distance using Wi-Fi Direct, Bluetooth™ (technical standard of the IEEE 802.15.1), ZigBee™ (technical standard of the IEEE 802.15.4), or the like.

Meanwhile, all components shown in FIG. 1 do not need to be included in the vehicle 1. For example, at least one of the camera 120 or lidar 140 may be omitted.

Further, although the drawings illustrate the camera 120, the radar 130, and the lidar 140 are components of the driving assistance system 100, these components do not need to be physically included in the driving assistance system 100.

Accordingly, at least one of the camera 120, the radar 130, or the lidar 140 may be provided in the vehicle 1 as a component independent of the driving assistance system 100, and the driving assistance system 100 may acquire the image data or camera track, the radar data or radar track, or the lidar data or lidar track from at least one of the camera 120, the radar 130, or the lidar 140 provided in the vehicle 1.

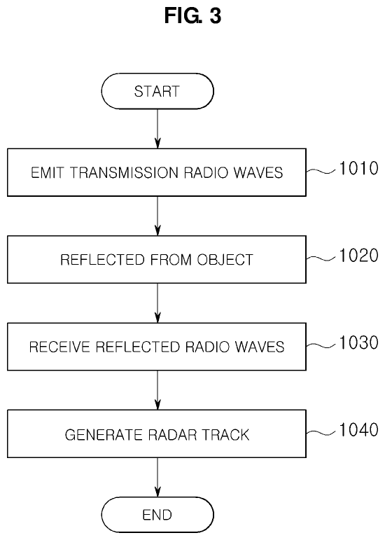

FIG. 3 is a flow chart illustrating a general process in which the radar track is generated.

Referring to FIG. 3, the transmission antenna of the radar emits the transmission radio waves (1010), and when the transmission radio waves are reflected from the objects and then return (1020), the reception antenna of the radar receives the reflected radio waves (1030).

The controller may generate the radar track using the reflected radio waves (1040).

Meanwhile, the vehicle is driven in various weather conditions. For example, the vehicle is driven in a rainy environment or snowy environment, and in this case, a false radar track may be generated even when there is no actual object due to a reflected signal (hereinafter, referred to as a noise signal) generated by rain or snow falling around the vehicle or spray generated by movement of the vehicle.

Since the physical generation amount of the noise signal changes according to the precipitation amount and thus a distance, an angle, a speed, an intensity, and the like measured by the radar 130 are changed, there is a difficulty of specifying the range of the noise signal.

When the noise signal is removed without considering the precipitation amount, signals reflected from objects which need to be detected, such as actual surrounding vehicles, pedestrians, or the like may also be removed, and this may cause deterioration of radar performance.

Accordingly, the present disclosure provides a driving assistance system and a driving assistance method capable of improving the performance of the radar by reflecting the precipitation amount to filter the noise signal.

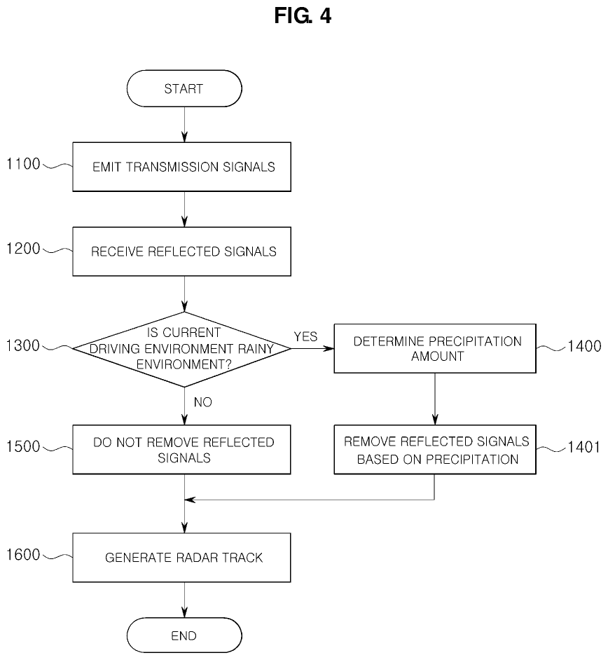

FIG. 4 is a flow chart related to a driving assistance method according to one embodiment.

The driving assistance method according to one embodiment may be performed by the above-described driving assistance system 100 or the vehicle 1 including the driving assistance system 100. Accordingly, the above-described contents of the driving assistance system 100 or the vehicle 1 may be equally applied to the embodiment of the driving assistance method, even if not separately mentioned. Conversely, the following description of the embodiment of the driving assistance method may also be equally applied to the embodiment of the driving assistance system 100 or the vehicle 1 including the driving assistance system 100.

Referring to FIG. 4, the radar 130 emits transmission signals (1100) and receives reflected signals reflected from an object (1200).

As described above, in a rainy environment or snowy environment, radio waves reflected by rain or snow, radio waves reflected by the spray generated by wheels of a vehicle, or the like may be included in the reflected signals.

According to one embodiment, when the current driving environment is a rainy environment or snowy environment, a noise signal included in the reflected signals may be removed based on the precipitation amount using the received reflected signals as they are without generating a radar track.

Specifically, the processor 112 determines whether the current driving environment is a rainy environment or snowy environment (1300).

Whether the current driving environment is a rainy environment or snowy environment may be determined based on an output of the rain sensor 80. Alternatively, determination may also be performed based on an output of the camera 120 or lidar 140.

When the current driving environment is not the rainy environment or snowy environment (No in 1300), a radar track is generated based on the reflected signals (1600) without filtering the reflected signals (1500).

When it is determined that the current driving environment is the rainy environment or snowy environment (Yes in 1300), the processor 112 may additionally determine the precipitation amount (1400).

The processor 112 may filter the reflected signals based on the determined precipitation amount (1401).

Hereinafter, a specific operation of filtering the reflected signals based on the precipitation amount will be described.

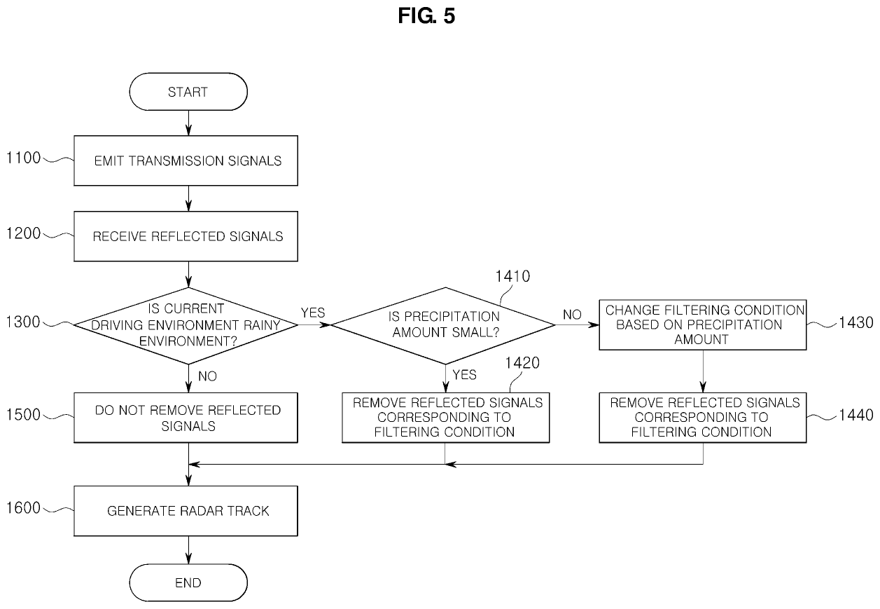

FIG. 5 is a flow chart which shows the operation of filtering the reflected signals in the driving assistance method according to one embodiment in detail.

Overlapping descriptions of the operations already described in FIG. 4 will be omitted.

For example, the processor 112 may classify the operation into an operation in which the precipitation amount is large and an operation in which the precipitation amount is small. To this end, the processor 112 may set a reference value capable of classifying whether the precipitation amount is large or small, determine that the precipitation amount is small when the precipitation amount measured by the rain sensor 80 or the like is smaller than the reference value, and determine that the precipitation amount is high when the measured precipitation amount exceeds the reference value.

As shown in FIG. 5, when it is determined that the precipitation amount is small (Yes in 1410), the reflected signals corresponding to a filtering condition are removed (1420).

For example, the filtering condition may include at least one of an angle, a speed, a distance, or an intensity corresponding to the reflected signal. Accordingly, the processor 112 may determine a reflected signal included in a range of the angle, the speed, the distance, and the intensity determined according to a filtering condition based on the radar 130 as a noise signal, and may remove the corresponding noise signal.

When the precipitation amount is small, a predetermined filtering condition may be used as a default. However, when the precipitation amount is large (No in 1410), the filtering condition may be changed based on the precipitation amount (1430).

Specifically, the processor 112 may change at least one of the angle, the speed, the distance, or the intensity included in the filtering condition based on the precipitation amount. The angle, speed, distance, or intensity condition of the noise signal generated according to the precipitation amount may be determined by a simulation, an experiment, or a specific rule, or may be determined by a trained model using collected data. In the embodiment, a method by which the processor 112 changes the filtering condition based on the precipitation amount is not limited.

The processor 112 removes the reflected signal corresponding to the changed filtering condition (1440). In other words, the processor 112 may determine the reflected signal corresponding to the changed filtering condition as a noise signal, and remove the corresponding noise signal.

The processor 112 may generate a radar track using the reflected signal from which the noise signal is removed (1600).

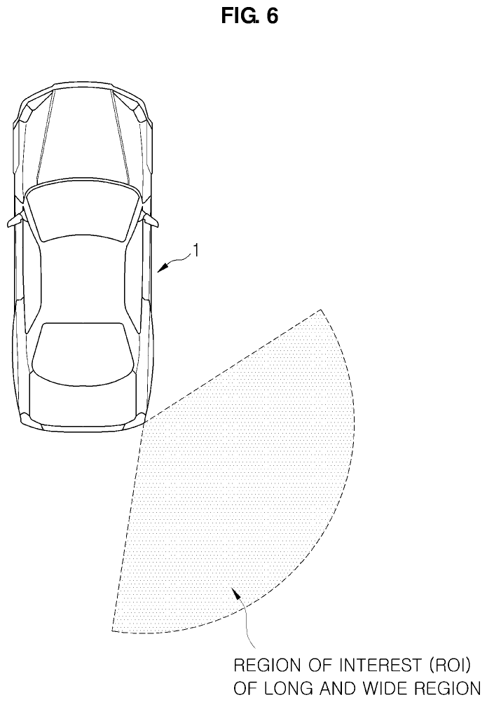

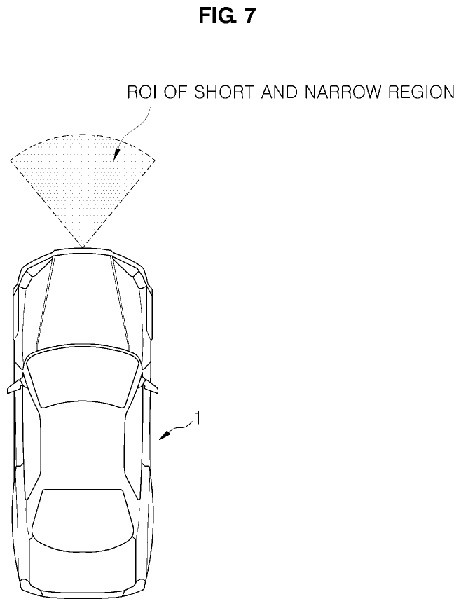

FIGS. 6 and 7 are views illustrating examples of a region of interest (ROI) of the radar included in the driving assistance system according to one embodiment.

As another example of determining the precipitation amount, a cumulative amount of a noise estimation signal detected within the ROI of the radar 130 may be used together with the output of the rain sensor 80.

The ROI of the radar 130 may be individually set according to the mounting position and function of the radar 130. Here, the ROI of the radar 130 may be defined by a distance and an angle. A long and wide ROI may be set as shown in FIG. 6, and a short and narrow ROI may be set as shown in FIG. 7.

The processor 112 may determine a signal which satisfies a fixed condition among the reflected signals received by the radar 130 in the ROI as a noise estimation signal. For example, a reflected signal having a signal intensity smaller than or equal to a predetermined reference value and a corresponding speed lower than the speed of the vehicle 1 may be determined as the noise estimation signal.

The processor 112 may further subdivide and determine the precipitation amount using the output of the rain sensor 80 and the cumulative amount of the noise estimation signal together.

For example, the processor 112 may determine that the precipitation amount is small (a first level) when the output of the rain sensor 80 indicates that the precipitation amount is small, and the cumulative amount of the noise estimation signal detected in the ROI for a specific time is smaller than a first reference value.

Further, the processor 112 may determine that the precipitation amount to be medium (a second level) when the output of the rain sensor 80 indicates that the precipitation amount is small, and the cumulative amount of the noise estimation signal detected in the ROI for a specific time is greater than or equal to the first reference value and smaller than a second reference value.

In addition, the processor 112 may determine that the precipitation amount is large (a third level) when the output of the rain sensor 80 indicates that the precipitation amount is large, and the cumulative amount of the noise estimation signal detected in the ROI for a specific time is greater than or equal to the second reference value and smaller than a third reference value.

In addition, the processor 112 may determine that the precipitation amount is very large (a fourth level) when the output of the rain sensor 80 indicates that the precipitation amount is large, and the cumulative amount of the noise estimation signal detected in the ROI for a specific time is greater than the third reference value.

The processor 112 may change the filtering condition differently according to the subdivided and classified precipitation amount. Accordingly, performance degradation of the radar 130 due to the rainy environment or snowy environment may be more effectively prevented.

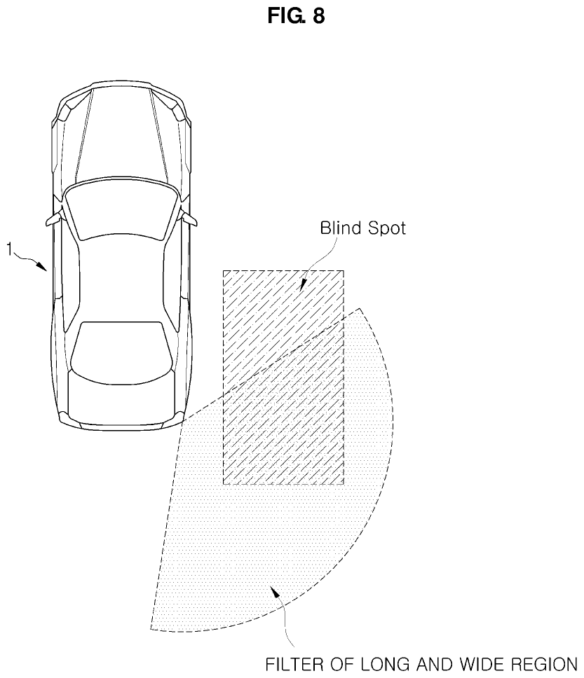

FIGS. 8 to 10 are views illustrating examples of the filtering condition applied to the driving assistance system and the driving assistance method according to one embodiment.

A factor such as the distance, speed, angle, or intensity included in the above-described filtering condition may be changed according to the mounting position or function of the radar 130 in addition to the precipitation amount.

For example, when the radar 130 mounted on the rear of the vehicle 1, water spray (spray) may be generated for a long time by the wheels of the vehicle 1, and the noise signal may affect the function of detecting a blind spot region. Accordingly, the angle and the distance included in the filtering condition may be set to be large so that a filtering region defined by the filtering condition may be formed to be long and wide as shown in FIG. 8.

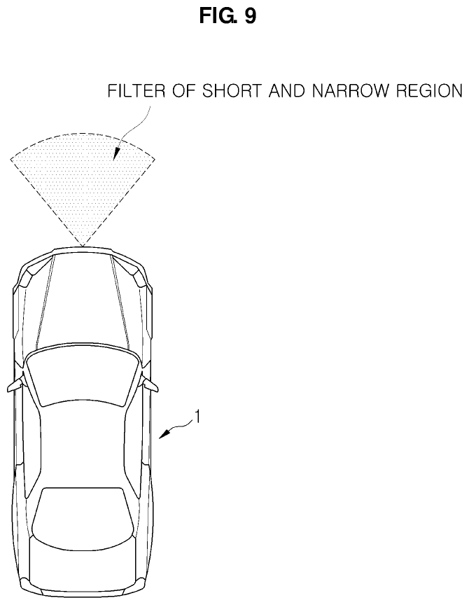

Further, when the radar 130 mounted on the front of the vehicle 1, the angle and the distance included in the filtering condition may be set to be small so that the filtering region may be formed to be small and narrow as shown in FIG. 9 based on a case in which the water spray is not generated for a long time and a function operates in a narrow angular region.

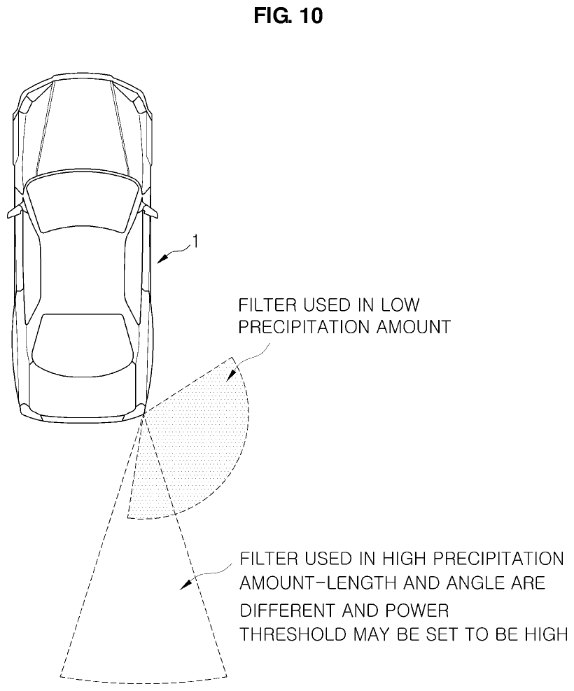

Alternatively, it is also possible to set a plurality of filtering conditions for one radar 130 and selectively apply the filtering conditions according to the precipitation amount. For example, as shown in FIG. 10, for the radar 130 mounted on the rear, when the precipitation amount is small, the filtering condition may be set so that the filtering region be formed to be short and narrow, and when the precipitation amount is large, a length and an angle of the filtering region may be set differently, and a threshold value of an intensity may be set to be high.

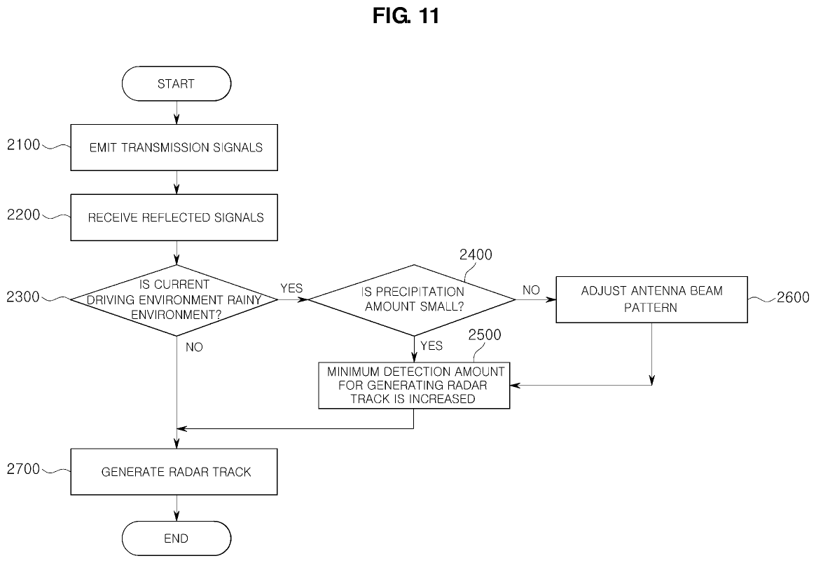

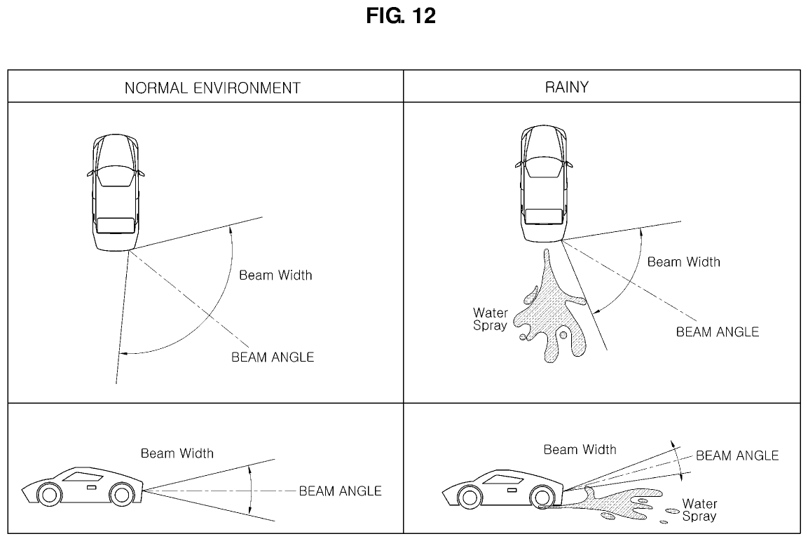

FIG. 11 is a flow chart of a driver's control method according to another example, and FIG. 12 is a view illustrating a control operation according to a driver's control method according to another embodiment.

The above-described driving assistance system 100 and the vehicle 1 including the same may be used when performing the driver's control method according to another embodiment. Accordingly, contents of the driving assistance system 100 and the vehicle 1 including the same may be applied to the driver's control method according to the embodiment even if not separately mentioned, and on the other hand, the following contents of the driver's control method may also be applied to the driving assistance system 100 and the vehicle 1.

Referring to FIG. 11, when the radar 130 emits the transmission signals (2100), and the transmission signals are reflected from the object, the reflected signals are received (2200).

The processor 112 may determine whether the current driving environment is a rainy environment or snowy environment (2300), and when the current driving environment is the rainy environment or snowy environment (Yes in 2300), the precipitation amount may be determined (2400). The operations up to here are the same as the contents of the above-described driving assistance method according to the embodiment.

When the precipitation amount is included in a first range, for example, when the precipitation amount is small (Yes in 2400), the processor 112 may increase a minimum detection amount for generating a radar track (2500). That is, the generation of a false track due to rain or snow may be suppressed by desensitizing the radar 130.

When the precipitation amount is included in a second range, for example, when the precipitation amount is large (No in 2400), the processor 112 may adjust an antenna beam pattern to avoid a water spray section (2600).

When the radar 130 is desensitized or the antenna beam pattern is adjusted according to the precipitation amount, the processor 112 may generate a radar track using the received reflected signals (2700).

As shown in FIG. 12, in a rainy environment or snowy environment, in order to avoid the water spray section, a beam width and beam angle may be adjusted differently from a normal environment. Here, the beam width may be an elevation beam width or an azimuth beam width.

As an example for this operation, it is possible to design a first antenna among a plurality of transmission antennas to suit a normal environment and design a second antenna among the plurality of transmission antennas to suit a rainy environment or snowy environment. Further, the beam width and beam angle may be adjusted differently in the normal environment and the rainy environment or snowy environment by toggling on/off of the first antenna and the second antenna according to the determination of whether or not there is precipitation.

Meanwhile, the embodiment in which the radar 130 is desensitized or the antenna beam pattern is adjusted may be combined with the above-described embodiment in which the filtering condition is changed according to the precipitation amount. In this case, when the precipitation amount is small, the filtering of the noise signal may be performed according to the determined filtering condition while desensitizing the radar 130, and when the precipitation amount is large, the filtering condition may be changed while adjusting the antenna beam pattern, and the filtering of the noise signal may be performed according to the changed filtering condition.

The disclosed embodiments may be implemented in a form of a recording medium which stores instructions executable by a computer. For example, instructions for performing the above-described driving assistance method may be stored in a form of program code, and may perform operations of the disclosed embodiments when executed by a processor. The recording medium may be implemented as a computer-readable recording medium.

Computer-readable recording media include all types of recording media in which instructions that can be decoded by a computer are stored. For example, the recording media may include a read only memory (ROM), a random access memory (RAM), a magnetic tape, a magnetic disk, a flash memory, an optical data storage device, and the like.

A storage medium readable by devices may be provided in a form of a non-transitory storage medium. For example, the non-transitory storage medium may include a buffer in which data is temporarily stored.

According to the above-described embodiment, radar performance may be improved by adjusting the filtering condition differently according to the precipitation amount in a rainy environment or snowy environment or performing another control operation (radar desensitization or antenna beam pattern adjustment).

According to one aspect of the present disclosure, deterioration of radar performance due to rain or snow in a rainy environment or snowy environment can be prevented by reflecting environmental influences to remove noise signals of the radar.

Accordingly, in a rainy environment or snowy environment, it is possible to prevent a false warning from being generated or wrong control from being performed due to false detection of a radar.

Further, active noise filtering suitable for a driving environment can be performed by setting a filtering condition according to the precipitation amount when a noise signal is removed.

Like the above, the disclosed embodiments have been described with reference to the accompanying drawings. Those skilled in the art will understand that the present disclosure may be embodied in forms different from the disclosed embodiments without changing the technical spirit or essential features of the present disclosure. The disclosed embodiments are exemplary and should not be understood as limiting.

What is claimed is:

1. A driving assistance system for a vehicle, the driving assistance system comprising:
a radar mounted on the vehicle, and configured to emit a transmission signal around the vehicle and receive reflected signals reflected from an object around the vehicle; and
a processor configured to filter a noise signal included in the reflected signals received by the radar in a rainy environment or snowy environment,
wherein the processor is configured to set a filtering condition of the noise signal based on precipitation amount, determine a reflected signal corresponding to the set filtering condition among the reflected signals received by the radar as the noise signal, and filter the determined noise signal.

2. The driving assistance system of claim 1, wherein the set filtering condition includes at least one of an angle corresponding to the reflected signal, a speed corresponding to the reflected signal, a distance corresponding to the reflected signal, and an intensity corresponding to the reflected signal.

3. The driving assistance system of claim 1, wherein the processor is configured to determine the precipitation amount based on an output of a rain sensor provided in the vehicle and a cumulative detection amount of the determined noise estimation signal included in the reflected signals.

4. The driving assistance system of claim 1, wherein the processor is configured to determine the precipitation amount based on at least one of an output of a rain sensor provided in the vehicle, an output of a camera provided in the vehicle, and an output of a light detection and ranging system (lidar) provided in the vehicle and the cumulative detection amount of the noise estimation signal included in the reflected signals.

5. The driving assistance system of claim 3, wherein the processor is configured to determine, among the reflected signals, a reflected signal having a detected intensity smaller than or equal to a threshold value and a corresponding speed smaller than a speed of the vehicle as the noise estimation signal.

6. The driving assistance system of claim 4, wherein the processor is configured to determine a reflected signal having a detected intensity smaller than or equal to a threshold value and a corresponding speed smaller than a speed of the vehicle as the noise estimation signal.

7. The driving assistance system of claim 1, wherein the processor is configured to adjust the filtering condition according to at least one of a mounting position and a function of the radar.

8. The driving assistance system of claim 7, wherein the processor is configured to set an angle and a distance included in the filtering condition to be large for a rear radar mounted on a rear of the vehicle, and set an angle and a distance included in the filtering condition to be small for a front radar mounted on the front of the vehicle.

9. A driving assistance system for a vehicle, the driving assistance system comprising:
a radar mounted on the vehicle, and configured to transmit a transmission signal around the vehicle, and receive reflected signals reflected from an object around the vehicle; and
a processor configured to cluster the reflected signals to generate a track corresponding to the object,
wherein the processor is configured to increase a minimum detection amount of the reflected signal for generating the track when precipitation amount is included in a first range, and adjust an antenna beam pattern of the radar to avoid a water spray section when the precipitation amount is included in a second range.

10. The driving assistance system of claim 9, wherein the processor is configured to adjust at least one of a beam width and a beam angle of the radar when the precipitation amount is included in the second range.

11. The driving assistance system of claim 10, wherein:
the radar includes a first transmission antenna used in a normal environment and a second transmission antenna used in a rainy environment; and
the processor is configured to turn on and off the first transmission antenna and the second transmission antenna based on the precipitation amount.

12. The driving assistance system of claim 11, wherein the processor is configured to turn on the first transmission antenna and turn off the second transmission antenna when the precipitation amount is included in the first range, and turn on the second transmission antenna and turn off the first transmission antenna when the precipitation amount is included in the second range.

13. A driving assistance method for a vehicle, the driving assistance method comprising:
emitting, by a radar mounted on the vehicle, a transmission signal around the vehicle;
receiving, by the radar, reflected signals reflected from an object around the vehicle; and
filtering a noise signal included in the reflected signals received by the radar in a rainy environment or snowy environment,
wherein the filtering includes setting a filtering condition of the noise signal based on the precipitation amount, determining a reflected signal corresponding to the set filtering condition among the reflected signals received by the radar as the noise signal, and filtering the determined noise signal.

14. The driving assistance method of claim 13, wherein the filtering condition includes at least one of an angle corresponding to the reflected signal, a speed corresponding to the reflected signal, a distance corresponding to the reflected signal, and an intensity corresponding to the reflected signal.

15. The driving assistance method of claim 13, wherein the filtering includes determining the precipitation amount based on an output of a rain sensor provided in the vehicle and a cumulative detection amount of the noise estimation signal included in the reflected signals.

16. The driving assistance method of claim 13, wherein the filtering includes determining the precipitation amount based on at least one of an output of a rain sensor provided in the vehicle, an output of the camera provided in the vehicle, and an output of a light detection and ranging system (lidar) provided in the vehicle and the cumulative detection amount of the noise estimation signal included in the reflected signals.

17. The driving assistance method of claim 15, wherein the filtering includes determining a reflected signal having a detected intensity smaller than or equal to a threshold value and a corresponding speed smaller than a speed of the vehicle as the noise estimation signal.

18. The driving assistance method of claim 16, wherein the filtering includes determining a reflected signal having a detected intensity smaller than or equal to a threshold value and a corresponding speed smaller than a speed of the vehicle as the noise estimation signal.

19. The driving assistance method of claim 17, wherein the filtering includes determining a reflected signal having the detected intensity smaller than or equal to the threshold value and a corresponding speed smaller than the speed of the vehicle as the noise estimation signal.

20. The driving assistance method of claim 13, wherein the filtering includes adjusting the filtering condition according to at least one of a mounting position and a function of the radar.
